(19) United States
(12) Patent Application Publication
(10) Pub. No.: US 2003/0177348 A1
(43) Pub. Date: Sep. 18, 2003

(54) Secure internet communication with small embedded devices

(76) Inventors: Andrew Davies, Bramley (GB); Kenneth Tindell, Kelfield (GB); Andrew Hutcheon, York (GB); Peter Fenelon, York (GB)

Correspondence Address: SHERIDAN ROSS PC, 1560 BROADWAY, SUITE 1200, DENVER, CO, 80202

(21) Appl. No.: 10/103,522

(22) Filed: Mar. 20, 2002

(30) Foreign Application Priority Data
Mar. 14, 2002 (GB) 0206017.6

(51) Int. Cl. H04L 9/00

(52) U.S. Cl. 713/153

(57) ABSTRACT

There are disclosed methods, systems and devices whereby SSL or TLS communications between an end-user such as a browsing agent and a small embedded device such as a microcontroller without substantial memory or processing power are made possible. One approach is to provide an interfacing computing device between the end-user and the embedded device comprising an SSL/TLS proxy server/router which translates between a relatively heavyweight encryption protocol used by the end-user and a relatively lightweight encryption protocol used by the embedded device. An alternative approach utilises an SSL/TLS assistant computing device that performs computationally expensive encryption/decryption calculations on behalf of the embedded device.

The present invention relates to methods and systems for enabling secure communication over the public Internet with small embedded computing devices.

Recently, there has been much development in the field of embedded devices adapted to be connected to the Internet or similar. An embedded device is generally in the form of a microcontroller or the like adapted to interact with a larger server or servers, thereby allowing a device (such as a vending machine, domestic electric appliance, motor vehicle etc.) to be remotely controlled and/or monitored from a central server by way of a standard protocol such as the Internet Protocol.

A common requirement of Internet-connected devices or servers is that it should be possible to communicate securely with them—more specifically, that it should be possible for data to be transmitted between such devices employing encryption algorithms. There are many de jure and de facto standards for secure encrypted communication, and embodiments of this invention relate to mechanisms generally used for communication between World Wide Web (WWW) browsers (clients) and servers known as Secure Socket Layer (SSL) and Transport Layer Security (TLS).

These mechanisms facilitate an encrypted communication link between a requesting client and a server over the public Internet, making use of a set of standard cryptographic algorithms negotiated between client and server. It is in the nature of such encryption algorithms that they are typically computationally expensive in terms of both space and execution time.

A major difficulty with small embedded devices is that they generally include microcontrollers or the like with very limited RAM and ROM, and slow Central Processing Units (CPUs). A typical microcontroller for use as an embedded device may have 32 kB of ROM and 1 kB of RAM, which is not enough to support the usual implementations of many communications protocols or cryptographic algorithms, and operate at slow clock rates (typically less than 20 MHz). The characteristics of such devices are such that implementation of the standard cryptographic algorithms used in SSL or TLS typically requires more RAM or ROM than is available to the device, and that generating encryption keys and/or encrypted data streams using those algorithms would be excessively slow. There exist a set of relatively lightweight cryptographic algorithms such as TEA (Tiny Encryption Algorithm) and Square which do not require expensive negotiation or computation and are ideally suited to implementation on small embedded devices, but are not a part of the standard SSL/TLS suite.

SSL/TLS is characterised by several phases of operation:

establishment of connection

presentation of certificate by server to client (and optionally vice-versa)

negotiation of cryptographic and hashing algorithms to be used (from a menu of standard algorithms)

session key generation

exchange of encrypted data

closure of connection

Of these, the session key exchange is generally very computationally expensive as it requires use of Diffie-Hellmann or RSA algorithms. The SSL/TLS certificate that must be presented by a server may also be larger than the available storage space on a small embedded device. It may be possible for some devices with less restrictive processors to carry out the exchange of encrypted data once the certification, session-ID and key exchange have been carried out on their behalf; some devices may be too small to even perform this part of the SSL/TLS process unassisted.

It is desirable to permit users of existing web-browsing software that can communicate using SSL and/or TLS to be able to access resources on such microcontrollers in a secure fashion.

Our first proposed solution is therefore one that permits a small embedded device to communicate using a lightweight cryptographic algorithm to a larger device acting as a router and proxy—this device communicates with end-users using standard SSL and TLS algorithms.

According to a first aspect of the present invention, there is provided a method of transmitting data between a first, embedded computing device with insufficient memory to process a standard encryption protocol such as Secure Socket Layer (SSL) or Transport Layer Security (TLS) and a second, standard computing device with sufficient memory to process a standard encryption protocol such as SSL or TLS, wherein the embedded device exchanges data with a third, interfacing computing device over a first communications link by way of a lightweight encryption protocol, the interfacing computing device translates the data between the lightweight encryption protocol and the standard encryption protocol, and the interfacing computing device exchanges data with the standard computing device over a second communications link by way of the standard encryption protocol.

According to a second aspect of the present invention, there is provided a data communications system comprising a first, embedded computing device with insufficient memory to process a standard encryption protocol such as Secure Socket Layer (SSL) or Transport Layer Security (TLS), a second, standard computing device with sufficient memory to process a standard encryption protocol such as SSL or TLS and a third, interfacing computing device that interfaces the embedded computing device and the standard computing device, wherein the embedded computing device is adapted to exchange data with the interfacing computing device over a first communications link by way of a lightweight encryption protocol, the interfacing computing device is adapted to translate data between the lightweight encryption protocol and the standard encryption protocol, and the interfacing computing device is adapted to exchange data with the standard computing device over a second communications link by way of the standard encryption protocol.

According to a third aspect of the present invention, there is provided an interfacing computing device adapted to exchange data with an embedded computing device with insufficient memory to process a standard encryption protocol such as Secure Socket Layer (SSL) or Transport Layer Security (TLS) over a first communications link by way of a lightweight encryption protocol, and to exchange data with a standard computing device with sufficient memory to process a standard encryption protocol such as SSL or TLS over a second communications link by way of the standard encryption protocol, wherein the interfacing computing device is adapted to translate data between the lightweight encryption protocol and the standard encryption protocol.

The interfacing computing device may be a proxy server/router adapted to translate data between the lightweight encryption protocol and a standard encryption protocol such as SSL or TLS. In other words, the interfacing computing device is adapted to use diverse cryptographic algorithms and to translate between them, thereby providing a substantially seamless communications link between the embedded computing device and the standard computing device, using a first set of computationally lightweight cryptographic algorithms for communication with the embedded computing device and a second set of relatively computationally heavyweight cryptographic algorithms (such as SSL or TLS or other algorithms) for communication with the standard computing device.

The standard computing device may be a standard personal computer or browsing agent as is commonly used for interfacing with the Internet or the like.

In order to guarantee that all communication between the embedded device and the standard computing device must pass through the interfacing device, it must be guaranteed that the interfacing device is on the route between the standard computing device and the embedded device. Since the standard computing device may be connected to the Internet or similar at an arbitrary point it is therefore preferable to place the interfacing device as “close” (with regard to network topology) to the embedded device as possible. It is preferred to do this by locating the interfacing computing device as part of an Internet Service Provider (ISP) point of presence used by the embedded device. In an appropriate network architecture, the embedded device connects directly to an Internet provider that is capable of speaking the lightweight cryptographic protocol over the link between the embedded device and the ISP, and capable of speaking the standard cryptographic protocol over links to the rest of the Internet. In this scenario, “lightweight” encryption advantageously only passes over a TCP/IP link or the like over which a provider of the lightweight cryptographic service has control. Accordingly, a preferred communications link between the embedded computing device and the interfacing computing device may be made secure, since it is part of a controlled network operated by a secure ISP, and is not used for public Internet traffic. There is no requirement for all stages in the interconnection between the embedded computing device and the interfacing computing device to be under the same control—it is merely sufficient to ensure that the interfacing computing device is encountered on all possible routes between the embedded computing device and the standard computing device. Cryptography protects the communication against interception on uncontrolled routes.

Given the use in embodiments of the present invention of two diverse cryptographic protocols—standard heavyweight protocols such as SSL/TLS spoken over the public Internet and lightweight cryptography spoken over a controlled part of the Internet, embodiments of the present invention seek to integrate these in order to give the appearance of an end-to-end SSL or TLS or similar connection to the small embedded device connected via the controlled part of the Internet.

In order to establish a secure link between a standard computing device (e.g. an end user) and a device offering some service secured by SSL or TLS or the like, there is conventionally a “socket” connection established between the end user and the device. The device is programmed to recognise connections to a particular “port” as needing to be encrypted according to the SSL/TLS specifications.

In order to establish an encrypted link between a server and an end-user there must take place a dialogue during which an exchange of certificates, supported cryptographic algorithms and session keys takes place. As has already been discussed, a small microcontroller acting as a server typically has neither the computational capability to implement the necessary SSL/TLS cryptographic algorithms in a reasonably efficient fashion nor the memory space needed to hold certificates and/or the implementations of those algorithms.

The interfacing computing device of embodiments of the present invention must therefore act on behalf of the embedded device in order to establish a pair of cryptographic links (embedded device to interfacing computing device, and interfacing computing device to standard computing device). Stateful inspection, interception and modification of network traffic flowing between the embedded computing device and the standard computing device bring this about.

The interfacing computing device (which may be configured as a proxy server acting as a router directing network traffic to and from the embedded computing device) is aware that connections to certain “ports” on the embedded computing device must appear to the outside world to be using a standard encryption protocol such as SSL or TLS.

The interfacing computing device must therefore intercept all TCP/IP traffic or the like addressed to a secure port on the small embedded device. Advantageously, the interfacing computing device (proxy server) must do the following:

Maintain two interacting TCP/IP state machines, one of which (call this Machine A) is synchronised with a state machine on the small embedded device and the other of which (Machine B) is synchronised with a state machine on the remote end-user standard computing device such that both can operate in such a fashion that they need not be aware that a third party is modifying their network traffic. These two TCP/IP state machines share knowledge of segment “sequence numbers” that are used by the TCP/IP stacks on the embedded computing device and the standard computing device such that TCP/IP segments modified by the interfacing computing device (i.e. those that would in a conventional implementation be part of the SSL/TLS traffic between the embedded computing device and the standard computing device) retain the same sequence numbers on both state machines both:

(a) when segments are modified by the proxy server—i.e. are translated from one cryptosystem to another; and

(b) when additional segments are transmitted between the interfacing computing device and the standard computing device that form part of the SSL/TLS dialogue between them but do not have a corresponding embodiment in the dialogue between the interfacing computing device and the embedded computing device.

The state machines themselves never issue acknowledgements to TCP/IP segments sent as part of the data stream between the embedded computing device and the standard computing device. They are passed on transparently with the expected sequence numbers to the appropriate destinations.

When a secure connection is requested:

Here it is desirable for the embedded device and the proxy server to authenticate themselves to each other (though this authentication may be persistent across a number of SSL/TLS or the like connections). The protocol for this authentication should involve no cryptographic or hash algorithms beyond those that the embedded device already supports. A suitable but simple exchange could be:

Embedded device generates a random number R1 and generates a hash of this, its unique device ID and a shared secret—sends R1, device ID + hash to the proxy server.

The proxy server adds shared secret, computes the hash and verifies it against the one the embedded device sent. If this is OK, the proxy server knows that the embedded device is what it claims to be. The proxy server then generates its own random number R2, and generates a hash of this and the shared secret—the random number and hash are then back sent to the embedded device.

The embedded device adds the shared secret to R2, computes the hash of these and verifies it against the one the proxy server sent. If this is OK then both the embedded device and the proxy server have exchanged knowledge of the shared secret and can continue to communicate.

Create a connection as normal, synchronising State Machine A with the TCP/IP stack on the embedded device and holding this in a suitable state until the negotiation described below is completed.

Perform on behalf of the small embedded device a dialogue with the end-user machine whose objective is the negotiation of certificates, cryptographic algorithms and session keys to be used over the link between State Machine B and the end-user device. All TCP/IP segments sent from the proxy server in this dialogue shall have their headers modified such that they appear to have originated from the small embedded device. During this dialogue no communication will be made over the TCP/IP connection between State Machine B and the end-user device.

Perform on behalf of the end-user device a dialogue with the small embedded device, the objective of the dialogue being the negotiation of a session key for the lightweight cryptographic protocol to be spoken over the link between State Machine A and the small embedded device. During this dialogue no communication will be made over the TCP/IP connection between State Machine A and the small embedded device.

Now that keys are established for both connections, the following occurs:

Small embedded device wishes to send some data to the end-user:

Software within the small embedded device encrypts the data according to the lightweight cryptographic algorithm and key used in the link between the embedded device and State Machine A, addressing the segments used to send the data to the end-user device.

The data is written over the network link and since the proxy server is acting as a router between the small embedded device and the end-user device it is able to intercept this.

The proxy server decrypts the received data and re-encrypts it according to the standard (e.g. SSL/TLS) algorithms and keys negotiated with the end-user device.

The proxy server constructs a TCP/IP segment encapsulating this encrypted data, and modifies the headers of the segment such that it appears to have originated from the small embedded device. This is written over the link between State Machine B and the end-user device—hence the end-user device “believes” that it has received standard encrypted (e.g. SSL/TLS) communications from the small embedded device.

End-user device wishes to send some data to the small embedded device:

The end user device sends data using its own implementation of a standard encryption protocol (e.g. SSL/TLS), addressing the segments used to send the data to the small embedded device.

The data is written over the network link and since the proxy server is acting as a router between the small embedded device and the end-user device it is able to intercept this.

The proxy server decrypts the received data and re-encrypts it according to the lightweight algorithms and keys negotiated with the end-user device.

The proxy server generates TCP/IP segments encapsulating this encrypted data, and modifies the headers of the segments such that they appear to have originated from the end-user device. This is written over the link between State Machine A and the small embedded device.

The embodiments of the present invention described above are applicable to even the smallest embedded devices, as the device itself need not be aware that SSL/TLS or the like is being spoken. It is applicable only when the link from the small embedded device to the Internet is under the control of the provider of the SSL/TLS Proxy/Router or the like. It is therefore a solution that is only applicable to a particular subset of potential Internet configurations and depends upon use of specific ISPs. A more generic solution (although one that involves slightly more computational effort on the part of the small embedded device) is described below.

According to a fourth aspect of the present invention, there is provided a method of transmitting data to a first, embedded computing device from a second, standard computing device with sufficient memory to process a standard encryption protocol such as SSL or TLS, wherein an encrypted data message is sent from the standard computing device to the embedded device over a first communications link, the encrypted data message is decrypted by a decryption process, a first predetermined part of which is handled by the embedded computing device and a second predetermined part of which is handled by a third, assistant computing device linked to the embedded device by way of a second communications link.

Advantageously, a response data message may subsequently be sent from the embedded device to the standard computing device over the first communications link, the response data message being encrypted by an encryption process, a first predetermined part of which is handled by the embedded computing device and a second predetermined part of which is handled by the assistant computing device.

According to a fifth aspect of the present invention, there is provided a data communications system comprising a first, embedded computing device, a second, standard computing device with sufficient memory to process a standard encryption protocol such as SSL or TLS, and a third, assistant computing device, wherein the embedded device is adapted to receive an encrypted data message sent from the standard computing device to the embedded device over a first communications link and to handle a first predetermined part of a data decryption process, the assistant computing device being linked to the embedded device by way of a second communications link and being adapted to handle a second predetermined part of the data decryption process.

Advantageously, the embedded device is adapted to transmit a response data message to the standard computing device over the first communications link, the response data message being encrypted by an encryption process, the embedded device being adapted to handle a first predetermined part of the encryption process and the assistant computing device being adapted to handle a second predetermined part of the data encryption process.

In both the fourth and fifth aspects, the two communications links may be logically distinct but share the same physical medium at the embedded device end (for example, they could be Internet connections to two entirely separate devices made over the same telephone line or Ethernet cable)

According to a sixth aspect of the present invention, there is provided an assistant computing device adapted for connection to an embedded computing device which in turn is adapted for connection to a standard computing device and for exchanging encrypted data messages therewith, wherein the assistant computing device is adapted to handle a predetermined part of a data decryption and/or encryption process that is too computationally expensive for the embedded device to handle by itself.

The assistant computing device of the fourth, fifth and sixth aspects of the present invention serves to handle the more computationally expensive parts of a decryption/encryption process, which parts cannot be handled in their entirety or even at all by a small embedded device with limited memory and processing power.

The assistant computing device may, for example, perform computationally expensive parts of an SSL or TLS or the like connection process between the standard computing device (e.g. a remote browsing agent) and the embedded device on behalf of the embedded device itself, and may also store information pertaining to the SSL or TLS or the like connection, such as session keys, certificates etc. This information and the results of any encryption/decryption calculations may be provided by the assistant computing device to the embedded device as and when required.

SSL/TLS and the like allows devices to negotiate from a range of hashing and cryptographic algorithms that may be used for authentication and encryption. Embodiments of the fourth, fifth and sixth aspects of the present invention preferably require that the small embedded device is capable of supporting at least a minimal set of algorithms required to sustain an SSL/TLS link (for example, 56-bit Data Encryption Standard (DES) and Message Digest 5 (MD5) hashing). However, the embedded device need not have sufficient permanent storage to store SSL/TLS certificates, and need not have the computational resources to compute and exchange session keys (this typically involves an expensive algorithm such as RSA) to establish a two-way cryptographic link. The assistant computing device assists the small embedded device in these areas.

The assistant computing device offers a range of remote-procedure-call services to perform the following functions on behalf of the small embedded device:

retrieve an SSL/TLS or the like certificate that the assistant device holds on behalf of the small embedded device. The embedded device returns the certificate to the browsing agent as though it held the certificate itself.

accept the encrypted form of the “master key” for the session generated by the browsing agent—this is forwarded by the small embedded device.

perform session key calculation—decrypt the encrypted form of the “master key” provided by the browsing agent, and apply one of a range of computationally expensive public-key cryptographic algorithms to generate a “session key” that the small embedded device can use. The session key is returned to the small embedded device.

If necessary, the data returned to the small embedded device may be encrypted and signed using the algorithms supported by the small embedded device for SSL/TLS or the like communication.

In a particularly preferred embodiment, the embedded device includes a TCP/IP stack programmed so as to detect an SSL or TLS or the like connection from the standard computing device, and then to forward information pertaining to the connection to the assistant computing device. The assistant computing device then processes the information in an appropriate manner, before returning the processed data to the embedded device for incorporation into the embedded device's response to the standard computing device (e.g. a browsing agent).

The detection of an SSL/TLS or the like connection in the context of a small embedded device is simple—each TCP/IP “service” runs on a well-defined port number. Certain port numbers are associated statically with SSL/TLS or the like connections (for example, by convention, port 443 is used for secure web connections) and connections to these ports may be marked for special action as described below.

When the small embedded device recognises an incoming connection by a remote browsing agent on such a port it must do the following:

Acknowledge the opening of the connection to the remote browsing agent.

Accept a “client-hello” SSL/TLS or the like message from the browsing agent.

Establish a TCP/IP connection to the assistant computing device.

Here it is desirable for the embedded device and the assistant device to authenticate themselves to each other (though this authentication may be persistent across a number of SSL/TLS or the like connections). The protocol for this authentication should involve no cryptographic or hash algorithms beyond those that the embedded device already supports. A suitable but simple exchange could be:

Embedded device generates a random number R1 and generates a hash of this, its unique device ID and a shared secret—sends R1, device ID + hash to the assistant device.

The assistant device adds shared secret, computes the hash and verifies it against the one the embedded device sent. If this is OK, the assistant device knows that the embedded device is what it claims to be. The assistant device then generates its own random number R2, and generates a hash of this and the shared secret—the random number and hash are then back sent to the embedded device.

The embedded device adds the shared secret to R2, computes the hash of these and verifies it against the one the assistant device sent. If this is OK then both the embedded device and the assistant device have exchanged knowledge of the shared secret and can continue to communicate.

Request from the assistant device the embedded device's SSL/TLS or the like certificate and await a response.

Combine the connection identification (from the client-hello message), certificate, a random session-ID and the identifier for the cryptographic and hashing algorithms to be used into a valid “server-hello” message. No cryptographic/hashing negotiation is performed—the small embedded device typically offers only one symmetric cryptographic and one hashing algorithm.

Accept a “client-master-key” SSL/TLS or the like message from the browsing agent.

Forward the content of this message to the assistant device, passing it to the session-key-generation remote procedure call service, and note the session key the assistant device returns.

Accept a “client-finished” SSL/TLS or the like message from the browsing agent and verify the encrypted hash of this against all previous messages sent and received.

Construct a “server-finished” SSL/TLS or the like message containing an encrypted hash of all messages exchanged so far and a new session-ID to be used for the exchange of data.

The small embedded device and the browsing agent are now able to communicate using the cryptographic and hash algorithms as suggested by the small embedded device above, with no further intervention by the assistant device.

It is interesting to note the cryptographic requirements of the communication between the small embedded device and the assistant device. Any data sent by the embedded device to the assistant device need not be encrypted—the small embedded device is merely repeating information passed to it by the browsing agent and there is therefore no compromise introduced by effectively “echoing” this up the line to the assistant device. Responses from the assistant device to the small embedded device should be encrypted (using the symmetric cryptographic algorithm supported by the small embedded device) if they correspond to data that would ordinarily never leave the embedded device (e.g. the session key to be used by the embedded device for the SSL/TLS communication), but can safely be sent in plaintext if they correspond to data that is transmitted onwards to the browsing agent (for example the SSL/TLS certificate). It is in fact advantageous to pass such data unencrypted—to do otherwise merely provides any attacker with a supply of plaintext and corresponding ciphertext that could be used as the basis for a cryptographic attack.

For a better understanding of the present invention and to show how it may be carried into effect, reference shall now be made by way of example to the accompanying drawings, in which:

FIG. 1 shows a large-scale architecture for a first embodiment of the present invention;

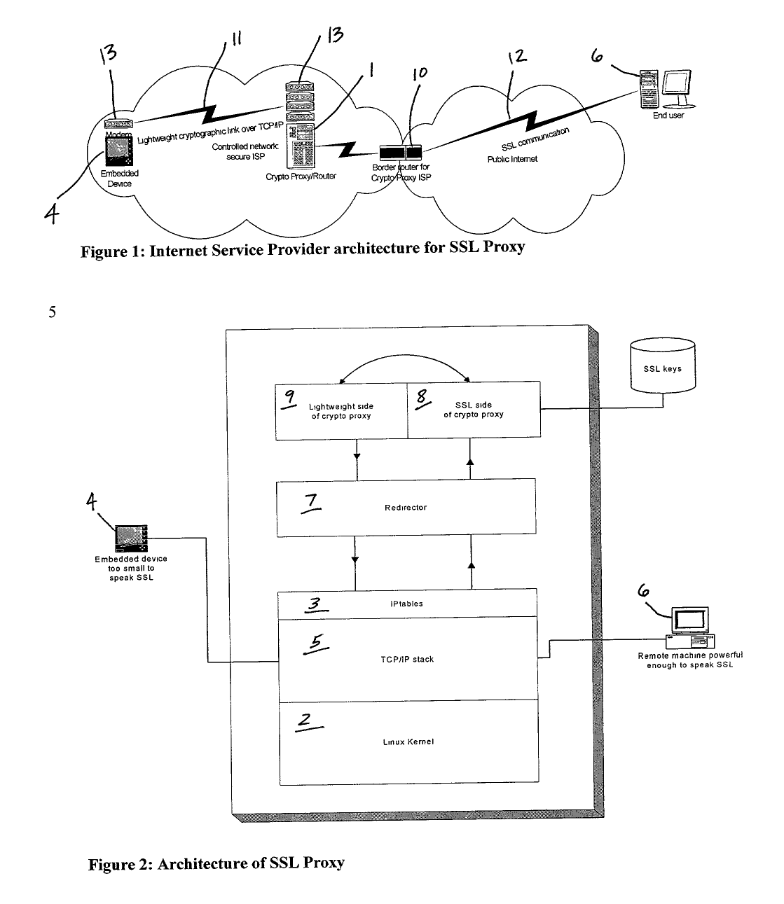

FIG. 2 shows a small-scale architecture for the first embodiment of the present invention; and

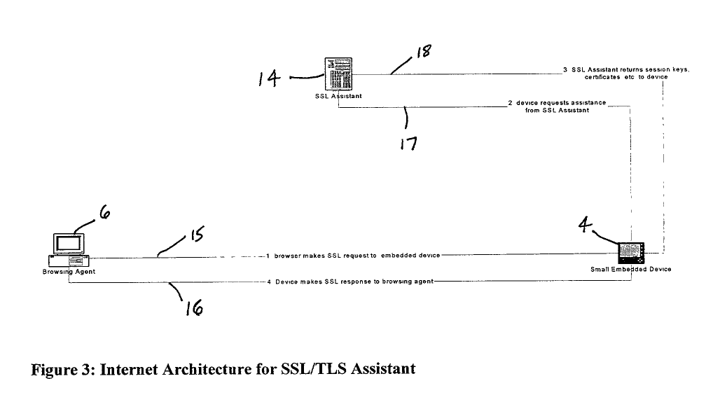

FIG. 3 shows a large-scale architecture for a second embodiment of the present invention.

A possible implementation of a first embodiment of the present invention according to the first, second and/or third aspects and comprising a computing system modified to act as an SSL proxy/router is described below with reference to FIGS. 1 and 2.

A microcomputer proxy 1 running the Linux operating system 2 is configured using its “IPtables” facility 3 to redirect (by way of a redirector 7) all traffic involved in SSL/TLS communications to and from small embedded devices 4 out of its own TCP/IP stack 5 and into a user-supplied function. This function is able to access the headers of TCP/IP segments such that various parts of the segment (source address, checksum, and possibly even data length) may be modified in order to maintain the appearance of an end-to-end connection between small embedded devices 4 and end-user devices 6. This function maintains State Machines A and B such that both are synchronised with the TCP/IP state machines of the devices 4, 6 with which they are communicating.

Because the proxy 1 modifies TCP/IP segment headers to ensure that it appears that SSL/TLS transmissions originate from the small embedded device 4, all SSL/TLS certificates held by the proxy server 1 on behalf of the embedded device 4 should use the embedded device's own fully-qualified domain name, rather than that of the server. Atop the redirector 7 are two pieces of cryptographic software 8, 9. The first 8 of these is a derivative of the standard “OpenSSL” reference implementation of the SSL/TLS protocols—this is responsible for the encryption and decryption of SSL traffic on the link between State Machine B and the end-user device 6. The second 9 of these uses a lightweight cryptographic algorithm and handles encryption and decryption of the traffic on the link between State Machine A and the small embedded device 4 as shown in FIG. 2.

As shown in FIG. 1, the embedded device 4 and the proxy 1 are contained within a controlled network run by a secure ISP. The proxy 1 communicates with a remote end-user 6 through a border router 10 over the public Internet. Also shown are the first 11 and second 12 communications links, which may include modems 13.

FIG. 3 shows an architecture of a second embodiment of the present invention according to the fourth, fifth and/or sixth aspects.

As before, there is provided an end-user or browsing agent 6 and an embedded device 4. There is also provided an SSL/TLS assistant device 14. Instead of the SSL/TLS assistant device 14 interfacing the end-user device 6 and the embedded device 4 as in FIGS. 1 and 2, the end-user device 6 and the embedded device 4 are in direct communication with each other by way of communications links 15, 16. The assistant device 14 is independently connected to the embedded device 4 by way of communications links 17, 18. When the end-user device 6 makes an SSL request to the embedded device 4 along communications link 15, and the embedded device 4 is unable to process the communication due to lack of memory or processing power, the embedded device 4 requests assistance from the assistant device 14 by way of communications link 17. The assistant device 14 can retrieve an appropriate SSL certificate held on behalf of the embedded device 4 and pass this, by way of communications link 18, to the embedded device 4 for onward transmission to the end-user 6 by way of communications link 16.

Furthermore, the assistant device 14 can accept an encrypted form of a “master key” for the session generated by the end-user 6, the “master key” merely being forwarded by the embedded device 4, and can also perform any required session key calculations on behalf of the embedded device 4.

1. A method of transmitting data between a first, embedded computing device with insufficient memory to process a standard encryption protocol such as Secure Socket Layer (SSL) or Transport Layer Security (TLS) and a second, standard computing device with sufficient memory to process a standard encryption protocol such as SSL or TLS, wherein the embedded device exchanges data with a third, interfacing computing device over a first communications link by way of a lightweight encryption protocol, the interfacing computing device translates the data between the lightweight encryption protocol and the standard encryption protocol, and the interfacing computing device exchanges data with the standard computing device over a second communications link by way of the standard encryption protocol.

2. A method according to claim 1, wherein the interfacing computing device is a proxy server/router adapted to translate between the lightweight encryption protocol and the standard encryption protocol.

3. A method according to claim 1, wherein the interfacing computing device is located as part of an Internet Service Provider (ISP) point of presence used by the embedded device.

4. A method according to claim 1, wherein the interfacing computing device intercepts all network TCP/IP traffic addressed from the standard computing device to a secure port on the embedded computing device.

5. A method according to claim 1, wherein the interfacing computing device maintains two interacting TCP/IP state machines, one of which is synchronised with a state machine on the embedded computing device and the other of which is synchronised with a state machine on the standard computing device.

6. A data communications system comprising a first, embedded computing device with insufficient memory to process a standard encryption protocol such as Secure Socket Layer (SSL) or Transport Layer Security (TLS), a second, standard computing device with sufficient memory to process a standard encryption protocol such as SSL or TLS and a third, interfacing computing device that interfaces the embedded computing device and the standard computing device, wherein the embedded computing device is adapted to exchange data with the interfacing computing device over a first communications link by way of a lightweight encryption protocol, the interfacing computing device is adapted to translate data between the lightweight encryption protocol and the standard encryption protocol, and the interfacing computing device is adapted to exchange data with the standard computing device over a second communications link by way of the standard encryption protocol.

7. A system as claimed in claim 6, wherein the interfacing computing device is a proxy server/router adapted to translate between the lightweight encryption protocol and the standard encryption protocol.

8. A system as claimed in claim 6, wherein the interfacing computing device is located as part of an Internet Service Provider (ISP) point of presence used by the embedded device.

9. A system as claimed in claim 6, wherein the interfacing computing device intercepts all network TCP/IP traffic addressed from the standard computing device to a secure port on the embedded computing device.

10. A system as claimed in claim 6, wherein the interfacing computing device maintains two interacting TCP/IP state machines, one of which is synchronised with a state machine on the embedded computing device and the other of which is synchronised with a state machine on the standard computing device.

11. An interfacing computing device adapted to exchange data with an embedded computing device with insufficient memory to process a standard encryption protocol such as Secure Socket Layer (SSL) or Transport Layer Security (TLS) over a first communications link by way of a lightweight encryption protocol, and to exchange data with a standard computing device with sufficient memory to process a standard encryption protocol such as SSL or TLS over a second communications link by way of the standard encryption protocol, wherein the interfacing computing device is adapted to translate data between the lightweight encryption protocol and the standard encryption protocol.

12. A device as claimed in claim 11, comprised as a proxy server/router adapted to translate between the lightweight encryption protocol and the standard encryption protocol.

13. A device as claimed in claim 11, located as part of an Internet Service Provider (ISP) point of presence used by the embedded device.

14. A device as claimed in claim 11, wherein the device intercepts all network TCP/IP traffic addressed from the standard computing device to a secure port on the embedded computing device.

15. A device as claimed in claim 11, wherein the device maintains two interacting TCP/IP state machines, one of which is synchronised with a state machine on the embedded computing device and the other of which is synchronised with a state machine on the standard computing device.

16. A method of transmitting data to a first, embedded computing device from a second, standard computing device with sufficient memory to process a standard encryption protocol such as SSL or TLS, wherein an encrypted data message is sent from the standard computing device to the embedded device over a first communications link, the encrypted data message is decrypted by a decryption process, a first predetermined part of which is handled by the embedded computing device and a second predetermined part of which is handled by a third, assistant computing device linked to the embedded device by way of a second communications link.

17. A method according to claim 16, wherein a response data message is subsequently sent from the embedded device to the standard computing device over the first communications link, the response data message being encrypted by an encryption process, a first predetermined part of which is handled by the embedded computing device and a second predetermined part of which is handled by the assistant computing device.

18. A method according to claim 16, wherein the encryption/decryption process takes place by way of an SSL or TLS connection.

19. A method according to claim 18, wherein SSL/TLS session keys or certificates are stored in the assistant computing device.

20. A method according to claim 18, wherein session key calculations are processed by the assistant computing device.

21. A method according to claim 18, wherein the embedded device includes a TCP/IP stack programmed to detect an SSL/TLS connection from the standard computing device and to forward information pertaining to the connection to the assistant computing device.

22. A method according to claim 21, wherein the assistant computing device processes the forwarded information in a predetermined manner before returning processed data to the embedded device for incorporation into the response data message.

23. A data communications system comprising a first, embedded computing device, a second, standard computing device with sufficient memory to process a standard encryption protocol such as SSL or TLS, and a third, assistant computing device, wherein the embedded device is adapted to receive an encrypted data message sent from the standard computing device to the embedded device over a first communications link and to handle a first predetermined part of a data decryption process, the assistant computing device being linked to the embedded device by way of a second communications link and being adapted to handle a second predetermined part of the data decryption process.

24. A system as claimed in claim 23, wherein the embedded device is adapted to transmit a response data message to the standard computing device over the first communications link, the response data message being encrypted by an encryption process, the embedded device being adapted to handle a first predetermined part of the encryption process and the assistant computing device being adapted to handle a second predetermined part of the data encryption process.

25. A system as claimed in claim 23, wherein the first communications link comprises an SSL or TLS connection.

26. A system as claimed in claim 25, wherein SSL/TLS session keys or certificates are stored in the assistant computing device.

27. A system as claimed in claim 25, wherein session key calculations are processed by the assistant computing device.

28. A system as claimed in claim 25, wherein the embedded device includes a TCP/IP stack programmed to detect an SSL/TLS connection from the standard computing device and to forward information pertaining to the connection to the assistant computing device.

29. A system as claimed in claim 28, wherein the assistant computing device processes the forwarded information in a predetermined manner before returning processed data to the embedded device for incorporation into the response data message.

30. An assistant computing device adapted for connection to an embedded computing device which in turn is adapted for connection to a standard computing device and for exchanging encrypted data messages therewith, wherein the assistant computing device is adapted to handle a predetermined part of a data decryption and/or encryption process that is too computationally expensive for the embedded device to handle by itself.

31. A device as claimed in claim 30, wherein the connection to the embedded computing device comprises an SSL or TLS connection.

32. A device as claimed in claim 31, wherein SSL/TLS session keys or certificates are stored therein.

33. A device as claimed in claim 31, wherein session key calculations are processed therein.
